(19) United States
(12) Patent Application Publication
(10) Pub. No.: US 2025/0371134 A1
(43) Pub. Date: Dec. 4, 2025

(54) TWO-STAGE SECURE DATA COLLABORATION

(71) Applicants: Lemon Inc., Cayman Islands (KY); Beijing Zitiao Network Technology Co., Ltd., Beijing (CN)

(72) Inventors: Dayeol Lee, Culver City, CA (US); Jianlin Jiang, Beijing (CN); Mingshen Sun, Culver City, CA (US); Wanrong Zhang, Culver City, CA (US); Xinhao Zhang, Culver City, CA (US); Yucheng Yang, Culver City, CA (US); Qiang Yan, Beijing (CN)

(21) Appl. No.: 19/221,068

(22) Filed: May 28, 2025

Related U.S. Application Data
(63) Continuation of application No. PCT/CN2024/096025, filed on May 29, 2024.

(51) Int. Cl. G06F 21/54; G06F 21/53; G06F 21/62

(52) U.S. Cl. CPC G06F 21/54; G06F 21/53; G06F 21/6218; G06F 2221/033

(57) ABSTRACT

Methods, systems, and apparatus, including computer programs encoded on computer storage media, for data collaboration. One of the methods includes executing a first data collaboration stage, comprising: obtaining a collection of data from a first entity; generating synthetic data from the collection of data; and generating, by a second entity, code defining one or more operations or queries executable on the collection of data and evaluated with respect to the synthetic data; and executing a second data collaboration stage, comprising: executing the code generated by the second entity in a secure execution environment, including executing one or more operations on the collection of data to generate one or more corresponding output results; and providing the output results to the second entity.

### CROSS-REFERENCE TO RELATED APPLICATIONS

This application is a continuation application of PCT Application No. PCT/CN2024/096025, filed on May 29, 2024, which is hereby incorporated by reference in its entirety.

### BACKGROUND

This specification relates to data collaboration.

Conventional data collaboration platforms allow data consumers to gain insights from data provided by a data provider. For example, a data consumer can perform data analysis operations on the provided data in which data results are generated responsive to various queries.

### SUMMARY

This specification describes technologies for providing data privacy protections during data collaboration while maintaining usability and accuracy. In particular, different privacy enhancing technologies can be used at different stages depending on the importance of different factors such as usability or accuracy at different steps of the data collaboration process. During a first stage, a data consumer can configure data analysis operations using synthetic data. During a second stage, the resulting operations are run in a trusted execution environment (TEE) on the actual data of the data provider. The first stage allows for customized operations and queries defined by the data consumer that ensures the usability of the data analysis results to the data consumer, without leaking any actual data. The second stage provides cryptographically secure data while providing for high accuracy. The output generated during the second stage can further undergo filtering before being provided to the data consumer.

In general, one innovative aspect of the subject matter described in this specification can be embodied in methods that include the actions of executing a first data collaboration stage, comprising: obtaining a collection of data from a first entity; generating synthetic data from the collection of data; and generating, by a second entity, code defining one or more operations or queries executable on the collection of data and evaluated with respect to the synthetic data; and executing a second data collaboration stage, comprising: executing the code generated by the second entity in a secure execution environment, including executing one or more operations on the collection of data to generate one or more corresponding output results; and providing the output results to the second entity. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages.

Separating the data collaboration system into different stages with different privacy protections allows for a more flexible system that can prioritize particular considerations at different stages. Allowing the data consumer to define operations and queries can enhance usability as compared to systems where data providers define allowable policies. However, the data providers can still control the execution and evaluate the final code for compliance. Data consumers can define operations that are tested on synthetic data that ensures a high degree of usability without leaking individualized data. Execution of the operations defined by the data consumers can provide high accuracy by using a trusted execution environment to securely provision and perform operations on the raw data provided by the data providers. The use of the trusted execution environment eliminates the need for trust between the data providers and data consumers.

By contrast, other collaboration systems can employ privacy measures at the execution stage that reduce accuracy, e.g., differential privacy. Additionally, other collaboration systems in which the data providers define the acceptable operations and queries typically lead to lower usability of the output by data consumers.

Policies of the data providers can be enforced on the generated output instead of the queries or code executing in the trusted execution environment. Thus, for example, output filtering can ensure that there is no privacy leakage in the output results. Consequently, the computed output is highly usable and accurate without employing additional policy or privacy enforcement at the computation stage. However, since these queries and operations may leak private data, the output filtering can detect and restrict such output.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are block diagrams of example data collaboration platforms.

FIG. 2 is a block diagram of an example two stage data collaboration architecture.

FIG. 3 is a flow diagram of an example process for generating code for the data collaboration platform.

FIG. 4 is a flow diagram of an example process for executing data collaboration in an execution environment.

FIG. 5 is a block diagram of an example computing system.

Like reference numbers and designations in the various drawings indicate like elements.

### DETAILED DESCRIPTION

Data collaboration platforms allow owners of data to make the data available to other entities, referred to as data consumers, to query the data or run particular algorithms on the data. The queries, algorithms, or other operations can be run to perform data analytics or other operations on the data. For example, a data provider may be a web service or content provider that possesses a large volume of user data. The data provider may make some or all of the data available to vetted researchers to perform social studies or other research investigations using the data. In addition, multiple data providers may also be data consumers. For example, credit card companies may want to collaborate to detect fraud, but do now want each other to directly access their own user transaction data.

The sharing of data in data collaboration platforms pose privacy and security risks if the data consumer cannot be fully trusted by the data provider. For example, a malicious data consumer might download the raw data and use it for a different purpose than those agreed to by the data provider.

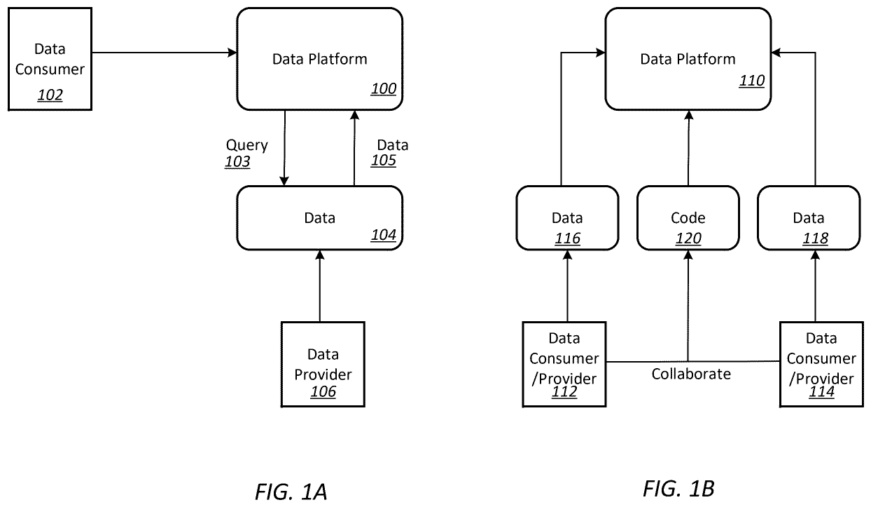

FIGS. 1A and 1B are block diagrams of example data collaboration platforms. In FIG. 1A, data collaboration platform 100 is used by a data consumer 102 to submit queries 103 to data 104 provided by data provider 106. In response to the queries 103 submitted through the data platform 100, data results 105 are returned in response to operations performed on the data 104 in response to the received queries.

In FIG. 1B, a multi-way data collaboration platform 110 is illustrated. Data consumer/providers 112 and 114 each provide data 116 and 118 for use by the data platform 110. The individual data consumer/providers 112 and 114 can also collaborate on code 120 defining how the provided data can be used. For example, the data consumer/providers 112 and 114 can collaborate on the operations or algorithms that can act on the respective data in response to queries from either of the data consumer/providers 112 and 114.

Tradeoffs can exist between usability and accuracy on the one hand and data privacy on the other. For example, some data collaboration platforms can operate without privacy protections, which provide high accuracy while other data collaboration platforms can employ data privacy techniques that reduce accuracy and/or usability. In another example, a secure processing environment can be used for the data collaboration platform, e.g., a trusted execution environment. However, typically the data consumers are more limited in the operations that they can perform on the data, leading to reduced utility.

To help secure the data, some data collaboration platforms are configured so that the data providers control the actions that can be performed on the data by the data consumers, for example, using data clean rooms. Additionally, differential privacy techniques can be used to add noise to data outputs from the data collaboration platform. However, the predefined controls can reduce the usability and the privacy techniques can reduce the accuracy of the data results obtained by the data consumer.

This specification describes technologies for providing data collaboration in a manner that protects user privacy without sacrificing usability and accuracy. In particular, a two stage solution is provided. During a first stage, a data consumer configures data analysis operations using synthetic data. During the first stage, usability may be the most important factor. During a second stage, the resulting operations are run on a trusted execution environment (TEE) on the actual data of the data provider. During the second stage, accuracy may be the most important factor. The data collaboration platform can be used with a distinct data consumer and data provider or with multi-way data collaboration where a given user entity is both a data consumer and a data provider.

The data collaboration platform can operate on a presumption that each entity does not trust the other participating entity or entities. In particular, the data provider does not trust the data consumer or consumers. As a consequence of this non-trust relationship, the data collaboration platform is configured such that data providers are able to control how the data is being used by data consumers as well as the data lifecycle. For example, data consumers should not be allowed to remove or copy the provider's data to their local machine where the data provider can no longer enforce controls over the data including data retention policies. Finally, data consumers should be able to use existing data analytics frameworks, for example, Jupyter Notebook, which provides an interactive environment for generating and running code using a computational notebook.

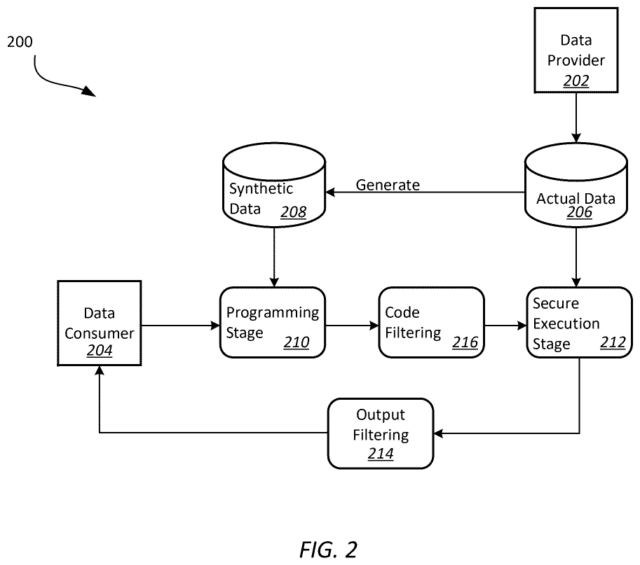

FIG. 2 is a block diagram of an example two stage data collaboration system 200. The data collaboration system includes a data provider 202 and a data consumer 204. In some implementations, there are multiple distinct data consumers 204. Additionally, the data provider and data consumer are entities that can each be associated with multiple distinct users and user devices

The data provider 202 provides data 206 to be accessible by the data consumer 204, e.g., to perform data analytics. The data 206 can be, for example, a collection of user data that can include information about the users, e.g., demographic information, as well as information about user interactions. For example, the data can be associated with a content providing system and the user interactions can relate to information about user interactions with the content provided by the platform. In another example, the data 206 can be associated with a financial institution and the user interactions can include user transactions associated with the financial institution. In some implementations, the data 206 can be anonymized, e.g., to eliminate user names, before being made available.

During the first stage, synthetic data 208 is generated from the actual data 206. The data consumer 204 uses the synthetic data 208 in a programming stage 210 to generate code defining the programming available to the data consumer to perform particular queries or algorithms on the actual data 206. The first stage allows the data consumer 204 to test computer programming on synthetic data having a similar structure or schema to the actual data. Queries can be tested to ensure that the code correctly generates output, even though the outputs are not based on real data since accuracy is not as important in the first stage as usability. Thus, the data consumer is able to determine code that provides a level of usability needed to perform the data analytics on the actual data.

The generated code is executed during the second stage in a secure execution environment 212, for example, a trusted execution environment (TEE), such that operations are performed on the data 206 according to queries, algorithms, or other operations initiated by the data consumer 204 on the TEE do not require trust between the data provider 202 and the data consumer 204. In particular, the TEE guarantees that the data 206 is provisioned securely, and in an encrypted form, and is protected during execution within the TEE hardware.

Before execution of the generated code in the secure execution environment 212, code filtering 216 can be performed by the data provider 202. The code filtering 216 allows the data provider to review the code generated during the programming stage 210 that is being submitted to the secure execution environment 212. In some implementations, the code filtering 212 can result in a rejection of providing any generated output from the secure execution environment with the data consumer 214, e.g., because the code indicates improper request, for example, for raw data records. In some other implementations, the code filtering result can be to request correction and resubmission by the data consumer 204 to correct one or more issues with the code. The issues can include identification of code that may reveal raw data in the generated output.

Output generated from the TEE undergoes output filtering 214 before being provided to the data consumer 204. For example, the output filtering 214 can ensure that the generated output does not leak any of the raw data from the data provider 206, but instead only includes aggregated results.

In some alternative implementations, in a multi-way data collaboration environment, the different data providers/consumers rely on the code filtering 216 rather than output filtering 214. In particular, each data provider can participate in code filtering before allowing execution to ensure compliance with data use policies (e.g., with respect to raw data) before running the code in the secure execution environment 212. In such a scenario, output filtering 214 is omitted since a data provider/consumer would see the output before output filtering.

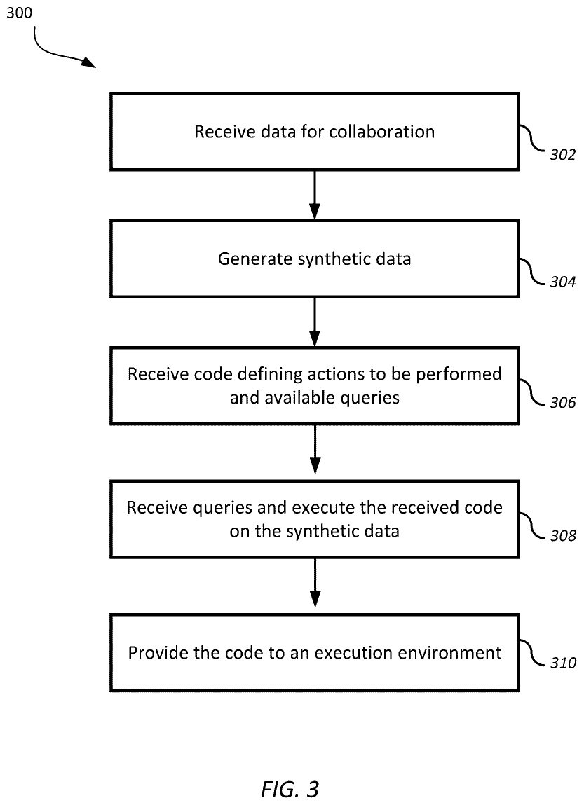

FIG. 3 is a flow diagram of an example process 300 for generating code for the data collaboration platform. For convenience, the process 300 will be described as being performed by a system of one or more computers, located in one or more locations, and programmed appropriately in accordance with this specification. For example, the two stage data collaboration system 200 of FIG. 2, appropriately programmed, can perform the process 300.

The system receives data for collaboration (302). The received data can be one or more datasets or portions of a dataset provided by a data provider for use in data collaboration with specified entities. The data can have a structure or a particular schema, for example, as tabular data. In one example, the data can be tabular data representing user data and having a number of columns representing different data attributes and a number of rows in which each row corresponds to a particular user account associated with the data provider.

The system generates synthetic data from the received data (304). The synthetic data represents data derived from the received data that, for example, has the same schema or properties of the actual data but not the actual values. For example, an attribute of the data might be the age of each user. The actual age values are modified, for example, by a random number, such that the synthetic data provides the property of ages, but not accurate values. The synthetic data can be operated on like the actual data, just without accuracy. For example, a query could be executed to identify a number of accounts where age is greater than 20. This operation would generate a result in the same manner as it would with the real data, but without revealing any sensitive information. In other words, the statistical character of the synthetic data is maintained without the actual values being used.

There are various suitable techniques for deriving the synthetic data from the real data. In some implementations, a differential privacy technique can be used to introduce random noise into the data values without modifying the data structure. In another example, each data value can simply be randomly adjusted according to a particular algorithm. Regardless, the synthetic data can be interacted with and acted on by the data consumer without any privacy leakage.

The system receives code defining actions to be performed and available queries (306). For example, the data consumer can generate code defining particular operations or algorithms to act on the data as well as the types or structure of queries that can be submitted. In other words, the data consumer defines a set of operations and queries corresponding to the analytics the data consumer seeks to perform on the actual data to ensure a particular usability of the data. One example way of generating the code for use on the data is to use Jupyter Notebook as an integrative framework that allows the user, e.g., of the data consumer entity, to draft code, e.g., Python, or SQL queries to perform on the data.

The system receives queries and executes the code on the synthetic data (308). The data consumer can test the generated code on the synthetic data to run test queries and evaluate results to determine whether the programmed code and queries provide the type of results needed by the data consumer to perform the analytics operations on the data. Thus, the data consumer can determine whether all of the operations and queries have been properly defined based on the performance using the synthetic data, which should be equally applicable to the actual data.

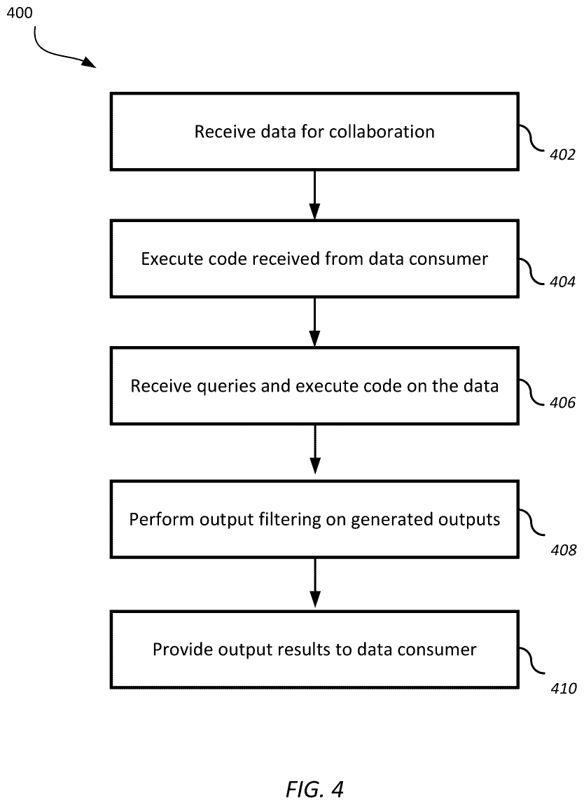

The system provides the code to an execution environment (310). Once the data consumer has completed the code generation, and optionally has tested it against the synthetic data, the data consumer can provide the code to a TEE. When executed in the TEE, the data consumer can perform operations or submit queries on the actual data of the data provider, which is described in greater detail below with respect to FIG. 4, representing the second data collaboration stage.

FIG. 4 is a flow diagram of an example process 400 for executing data collaboration in an execution environment. For convenience, the process 400 will be described as being performed by a system of one or more computers, located in one or more locations, and programmed appropriately in accordance with this specification. For example, the two stage data collaboration system 200 of FIG. 2, appropriately programmed, can perform the process 400.

The system receives data for collaboration (402). As described above with respect to FIG. 3, the received data can be one or more datasets or portions of a dataset provided by a data provider for use in data collaboration with specified data consumer entities.

The system executes code received from a data consumer (404). The code is executed within a particular execution environment. One example of an execution environment is a trusted execution environment (TEE). A TEE is a hardware security solution in which a secure area of a processor executes specific code. The hardware isolates the executable code so that it cannot be accessed by unauthorized entities. Additionally, the code being run can be cryptographically verified to ensure that the code in the secure execution stage corresponds to the expected code, e.g., codes as indicated to the data provider by the data consumer. Since the code has been generated by the data consumer separately, the supplied code is fixed and can be run in the TEE. This ensures that the code is not later modified, for example, from code approved by the data provider, to perform an unauthorized action.

In some implementations, before running the code in the execution environment, the code is audited by the data provider to determine that the operations performed and queries responded to do not provide private information. For example, the code is evaluated to determine that the data consumer cannot query for, and be provided with, a copy of the raw actual data. In another example, the code can be analyzed to identify attempts to generate raw user data in an output but obscure it within another structure, e.g., a graph structure that obscures underlying references to the raw data.

The system receives queries and executes the code on the data (406). In particular, the data consumer can submit queries or instructions to run particular operations defined by the code in the execution environment and on the actual data provided by the data provider. Because the operations are performed on the actual data, the results generated have a high degree of accuracy. Furthermore, since the operations are performed using code configured by the data consumer, the output results can also have a high degree of utility.

The system evaluates output results for output filtering (408). Before providing the results generated by the execution environment to the data consumer, the data provider can control what output to share with the data consumer. The filtering can occur after the entire execution in the execution environment instead of having to enforce, for example, different policies within the execution environment. This is in contrast to a system where the data provider specifies various policies as part of the code running in the execution environment, which requires fine grained policies that define what queries the data consumer can submit. Instead, the output can be analyzed to determine whether any filtering is needed before sending the output to the data consumer.

For example, since accuracy is important in the second stage, the filtering can be focused on identifying improper requests, for example, that provides some or all of the raw data as an output rather than, e.g., an aggregate computed result. For example, a request to print individual user data records. This can be detected in the output filtering stage and blocked. The filtering can be based on particular file types of the generated output or based on the content of the generated output. Additionally, the size of the generated output may indicate that it likely contains raw data, e.g., a very large table as an output. In some implementations, the output filtering is a manual process in which the output is reviewed by a user, e.g., associated with the data provider. In some other implementations, evaluation can be rule based or based on a machine learning model.

In some alternative implementations, some level of differential privacy can be applied to the output to enhance the privacy of the output. This can be small to limit the impact on accuracy of the generated outputs. For example, the privacy parameters can be set such that only a small deviation of noise is applied to output values to limit the effect on accuracy.

The system provides results to one or more data consumers (410). The output results, after any applied filtering, are then provided to one or more devices associated with the data consumer entity. The data consumer can then evaluate the outputs provided for particular queries or other operations performed on the data.

The two stage data collaboration system provides for a configuration that accounts for different tradeoffs at the different stages. During the first stage, the use of the private synthetic data allows for high utility in defining code to run on the actual data without concern for accuracy or risk of privacy leakage. During the second stage, the accuracy is high while using the trusted execution environment and output filtering to preserve the privacy of individual data records.

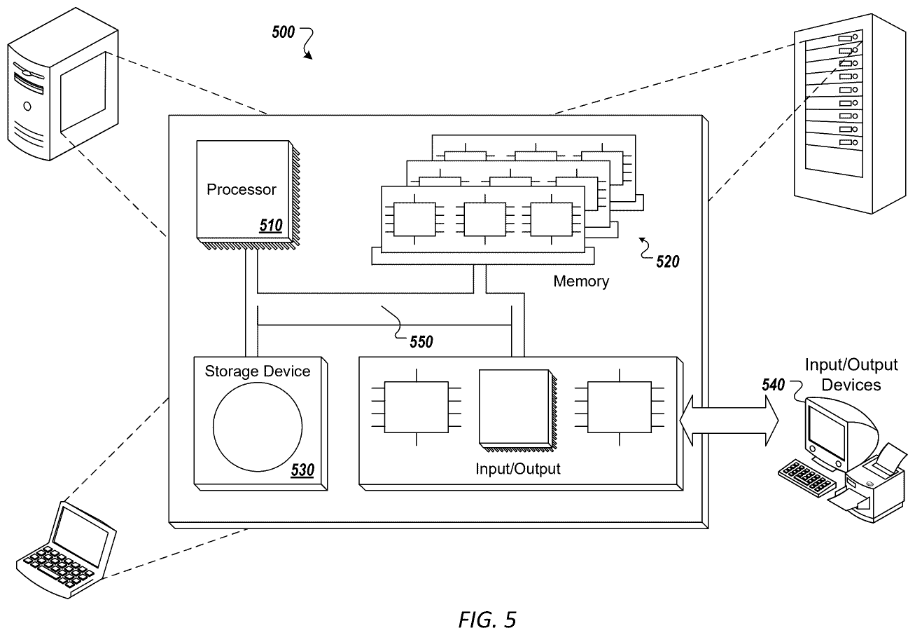

FIG. 5 is a block diagram of a schematic diagram of an example computing system 500. The system 500 can be used for the operations described in association with the implementations described herein. For example, the system 500 may be included in any or all of the components of the content delivery system or video processing systems discussed in this specification. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. The processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 can be a volatile memory unit or a non-volatile memory unit. The storage device 530 is capable of providing mass storage for the system 500. The storage device 530 is a computer-readable medium. The storage device 530 may be a floppy disk device, a hard disk device, an optical disk device, or a tape device. The input/output device 540 provides input/output operations for the system 500. The input/output device 540 includes a keyboard and/or pointing device. The input/output device 540 includes a display unit for displaying graphical user interfaces.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method, the method comprising: executing a first data collaboration stage, comprising: obtaining a collection of data from a first entity; generating synthetic data from the collection of data; and generating, by a second entity, code defining one or more operations or queries executable on the collection of data and evaluated with respect to the synthetic data; and executing a second data collaboration stage, comprising: executing the code generated by the second entity in a secure execution environment, including executing one or more operations on the collection of data to generate one or more corresponding output results; and providing the output results to the second entity.

Embodiment 2 is the method of embodiment 1, wherein generating synthetic data from the collection of data comprises applying a differential privacy operation to the collection of data to generate data having a same schema as the collection of data but with adjusted data values.

Embodiment 3 is the method of any one of embodiments 1 through 2, wherein generating synthetic data from the collection of data comprises applying a random value to each individual data value while retaining the data schema.

Embodiment 4 is the method of any one of embodiments 1 through 3, wherein secure execution comprises using a trusted execution environment to securely provision the collection of data from the first entity and perform computations according to the generated code.

Embodiment 5 is the method of any one of embodiments 1 through 4, further comprising performing output filtering to the output generated by the execution environment, wherein the output filtering evaluates the output results for privacy leakage through output results containing some of the original collection of data.

Embodiment 6 is the method of any one of embodiments 1 through 5, wherein the first entity corresponds to a data provider of a data collaboration system and the second entity corresponds to a data consumer of a data collaboration system.

Embodiment 7 is the method of any one of embodiments 1 through 6, wherein evaluating the generated code with respect to the synthetic data comprises testing the execution of the code including one or more queries on the synthetic data.

Embodiment 8 is the method of any one of embodiments 1 through 7, wherein executing the second data collaboration stage comprises auditing the code generated in the first data collaboration stage.

Embodiment 9, is the method of any one of embodiments 1 through 8, further comprising performing, by the first entity, code filtering on the generated code before execution in the secure execution environment.

Embodiment 10 is a system comprising: one or more computers and one or more storage devices storing instructions that are operable, when executed by the one or more computers, to cause the one or more computers to perform the method of any one of embodiments 1 to 9.

Embodiment 11 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
executing a first data collaboration stage, comprising:
obtaining a collection of data from a first entity;
generating synthetic data from the collection of data; and
generating, by a second entity, code defining one or more operations or queries executable on the collection of data and evaluated with respect to the synthetic data; and
executing a second data collaboration stage, comprising:
executing the code generated by the second entity in a secure execution environment, including executing one or more operations on the collection of data to generate one or more corresponding output results; and
providing the one or more corresponding output results to the second entity.

2. The method of claim 1, wherein generating synthetic data from the collection of data comprises applying a differential privacy operation to the collection of data to generate data having a same schema as the collection of data but with adjusted data values.

3. The method of claim 1, wherein generating synthetic data from the collection of data comprises applying a random value to each individual data value while retaining a data schema.

4. The method of claim 1, wherein secure execution comprises using a trusted execution environment to securely provision the collection of data from the first entity and perform computations according to the generated code.

5. The method of claim 1, further comprising performing output filtering to the output generated by the secure execution environment, wherein the output filtering evaluates the one or more corresponding output results for privacy leakage through output results containing some of the original collection of data.

6. The method of claim 5, wherein the first entity corresponds to a data provider of a data collaboration system and the second entity corresponds to a data consumer of a data collaboration system.

7. The method of claim 1, wherein evaluating the generated code with respect to the synthetic data comprises testing the execution of the code including one or more queries on the synthetic data.

8. The method of claim 1, wherein executing the second data collaboration stage comprises auditing the code generated in the first data collaboration stage.

9. The method of claim 1, further comprising: performing, by the first entity, code filtering on the generated code before execution in the secure execution environment.

10. A system comprising: one or more computers and one or more storage devices storing instructions that are operable, when executed by the one or more computers, to cause the one or more computers to operations comprising:
executing a first data collaboration stage, comprising:
obtaining a collection of data from a first entity;
generating synthetic data from the collection of data; and
generating, by a second entity, code defining one or more operations or queries executable on the collection of data and evaluated with respect to the synthetic data; and
executing a second data collaboration stage, comprising:
executing the code generated by the second entity in a secure execution environment, including executing one or more operations on the collection of data to generate one or more corresponding output results; and
providing the one or more corresponding output results to the second entity.

11. The system of claim 10, wherein generating synthetic data from the collection of data comprises applying a differential privacy operation to the collection of data to generate data having a same schema as the collection of data but with adjusted data values.

12. The system of claim 10, wherein generating synthetic data from the collection of data comprises applying a random value to each individual data value while retaining a data schema.

13. The system of claim 10, wherein secure execution comprises using a trusted execution environment to securely provision the collection of data from the first entity and perform computations according to the generated code.

14. The system of claim 10, further comprising performing output filtering to the output generated by the secure execution environment, wherein the output filtering evaluates the one or more corresponding output results for privacy leakage through output results containing some of the original collection of data.

15. The system of claim 14, wherein the first entity corresponds to a data provider of a data collaboration system and the second entity corresponds to a data consumer of a data collaboration system.

16. The system of claim 10, wherein evaluating the generated code with respect to the synthetic data comprises testing the execution of the code including one or more queries on the synthetic data.

17. The system of claim 10, wherein executing the second data collaboration stage comprises auditing the code generated in the first data collaboration stage.

18. The system of claim 10, further comprising: performing, by the first entity, code filtering on the generated code before execution in the secure execution environment.

19. One or more computer storage media encoded with a computer program, the program comprising instructions that are operable, when executed by data processing apparatus, to cause the data processing apparatus to perform operations comprising:
executing a first data collaboration stage, comprising:
obtaining a collection of data from a first entity;
generating synthetic data from the collection of data; and
generating, by a second entity, code defining one or more operations or queries executable on the collection of data and evaluated with respect to the synthetic data; and
executing a second data collaboration stage, comprising:
executing the code generated by the second entity in a secure execution environment, including executing one or more operations on the collection of data to generate one or more corresponding output results; and
providing the one or more corresponding output results to the second entity.

20. The computer storage media of claim 19, wherein generating synthetic data from the collection of data comprises applying a differential privacy operation to the collection of data to generate data having a same schema as the collection of data but with adjusted data values.
